(19) United States
(12) Patent Application Publication
(10) Pub. No.: US 2026/0155503 A1
(43) Pub. Date: Jun. 4, 2026

(54) SECONDARY BATTERY

(71) Applicant: MURATA MANUFACTURING CO., LTD., Kyoto (JP)

(72) Inventor: Kunio SODEYAMA, Kyoto (JP)

(21) Appl. No.: 19/346,785

(22) Filed: Oct. 1, 2025

(30) Foreign Application Priority Data
Dec. 3, 2024 (JP) 2024-210752

(51) Int. Cl. H01M 50/152; H01M 50/107; H01M 50/119; H01M 50/167; H01M 50/186; H01M 50/342

(52) U.S. Cl. CPC H01M 50/152; H01M 50/107; H01M 50/119; H01M 50/167; H01M 50/186; H01M 50/3425

(57) ABSTRACT

A secondary battery includes a battery device, a container, and a cover part. The container contains the battery device. The cover part includes a cover member and a valve member. The cover member includes a first flange. The valve member includes a second flange, and is positioned between the cover member and the battery device in a first direction. The first flange includes a lower surface, an upper surface, and an end surface. The second flange is folded back to continuously cover the first flange from the lower surface, via the end surface, to the upper surface. An upper surface covering part of the second flange includes a first part having a first thickness and a second part having a second thickness smaller than the first thickness. The second part is positioned between the first part and the end surface in a radial direction of the container.

### CROSS-REFERENCE TO RELATED APPLICATIONS

The present application claims priority from Japanese Patent Application No. 2024-210752 filed on Dec. 3, 2024, the entire contents of which are hereby incorporated by reference.

### BACKGROUND

The present disclosure relates to a secondary battery including a safety valve mechanism.

Various kinds of electronic equipment, including mobile phones, have been widely used. Such widespread use has invoked a need for a smaller size, a lighter weight, and a longer life of the electronic equipment. To address the need, a secondary battery having a smaller size, a lighter weight, and a longer life has been developed as a power source of the electronic equipment.

A secondary battery includes a positive electrode, a negative electrode, and an electrolytic solution. In order to suppress occurrence of malfunction due to a gas when the gas is generated due to, for example, a decomposition reaction of the electrolytic solution, the secondary battery includes a safety valve mechanism configured to release the gas to an outside on an as-needed basis.

### SUMMARY

A secondary battery according to an embodiment of the present disclosure includes a battery device, a container, and a cover part. The container contains the battery device. The container includes a first end part and a second end part. The second end part is positioned on an opposite side to the first end part in a first direction. The cover part is attached to the container with an insulating member interposed between the container and the cover part.

The cover part includes a cover member and a valve member. The cover member includes a first flange extending in a radial direction of the container. The radial direction is orthogonal to the first direction. The valve member includes a second flange. The second flange extends in the radial direction and overlaps the first flange in the first direction. The valve member is positioned between the cover member and the battery device in the first direction. The first flange includes a lower surface, an upper surface on an opposite side to the lower surface, and an end surface coupling the lower surface and the upper surface to each other. The second flange is folded back to continuously cover the first flange from the lower surface, via the end surface, to the upper surface. The second flange includes an upper surface covering part that covers the upper surface.

The upper surface covering part includes a first part having a first thickness and a second part having a second thickness that is smaller than the first thickness. The second part is positioned between the first part and the end surface in the radial direction.

### BRIEF DESCRIPTION OF THE FIGURES

The accompanying drawings are included to provide a further understanding of the present disclosure and are incorporated in and constitute a part of this specification.

The drawings illustrate example embodiments and, together with the specification, serve to explain the principles of the present disclosure.

FIG. 1 is a sectional diagram illustrating an overall configuration example of a secondary battery according to one example embodiment of the present disclosure.

FIG. 2 is a partial sectional diagram illustrating, in an enlarged manner, a configuration example of an upper part of the secondary battery illustrated in FIG. 1.

FIG. 3 is an enlarged sectional diagram illustrating, in an enlarged manner, a configuration example of a safety valve mechanism of the secondary battery illustrated in FIG. 1.

FIG. 4 is an exploded perspective diagram of the safety valve mechanism illustrated in FIG. 3.

FIG. 5 is a partial sectional diagram illustrating, in an enlarged manner, a configuration example of a crimp part and the vicinity thereof of the secondary battery illustrated in FIG. 1.

FIG. 6 is a schematic plan diagram of the safety valve mechanism illustrated in FIG. 3.

FIG. 7 is a sectional diagram illustrating, in an enlarged manner, a part of a configuration of a battery device illustrated in FIG. 1.

FIG. 8 is a sectional diagram for describing an operation of the secondary battery.

FIG. 9 is a partial sectional diagram illustrating, in an enlarged manner, a configuration example of a crimp part and the vicinity thereof of a secondary battery according to a first modification example.

FIG. 10 is a partial sectional diagram illustrating, in an enlarged manner, a configuration example of a crimp part and the vicinity thereof of a secondary battery according to a second modification example.

FIG. 11 is a partial sectional diagram illustrating, in an enlarged manner, a configuration example of a crimp part and the vicinity thereof of a secondary battery according to a third modification example.

FIG. 12 is a partial sectional diagram illustrating, in an enlarged manner, a configuration example of a crimp part and the vicinity thereof of a secondary battery according to a fourth modification example.

FIG. 13 is a block diagram illustrating a configuration of an application example of the secondary battery, which is a battery pack.

FIG. 14 is an explanatory diagram for describing a procedure of a voltage drop check test in each of Examples.

FIG. 15 is a schematic plan diagram of a safety valve mechanism of a secondary battery according to a fifth modification example.

### DETAILED DESCRIPTION

Consideration has been given in various ways to improve performance of a secondary battery. There is, however, still room for improvement in terms of the performance of the secondary battery.

It is therefore desirable to provide a secondary battery that is superior in safety.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an example embodiment of the present disclosure.

Although a charge and discharge principle of the secondary battery described herein is not particularly limited, the following description deals with a case where a battery capacity is obtained through insertion and extraction of an electrode reactant.

The secondary battery may include a positive electrode, a negative electrode, and an electrolyte. In the secondary battery, a charge capacity of the negative electrode may be greater than a discharge capacity of the positive electrode. For example, an electrochemical capacity per unit area of the negative electrode may be greater than an electrochemical capacity per unit area of the positive electrode. One reason for this is to prevent precipitation of the electrode reactant on a surface of the negative electrode during charging.

Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

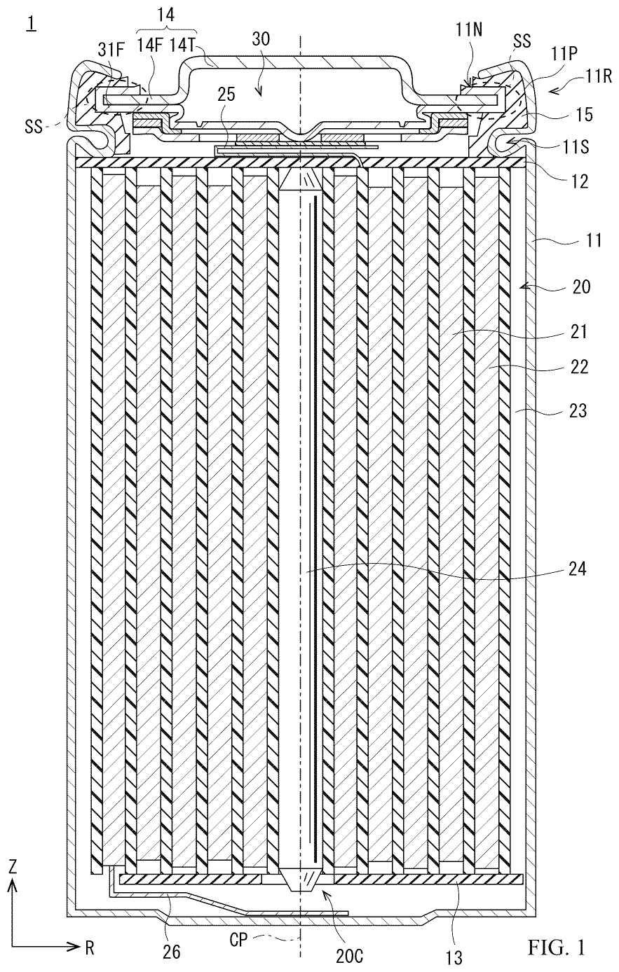

FIG. 1 illustrates a sectional configuration of a secondary battery 1. The secondary battery 1 includes a battery device 20 and a battery can 11, as illustrated in FIG. 1. The battery can 11 contains the battery device 20 inside the battery can 11. The battery can 11 may have a cylindrical shape. The secondary battery 1 may be what is called a secondary battery of a cylindrical type. A reference sign CP denotes a central axis of the secondary battery 1.

Hereinafter, a direction in which the battery device 20 is placed into the battery can 11, for example, a height direction of the battery can 11 having the cylindrical shape, is referred to as a Z direction; and a radial direction of the battery can 11 having the cylindrical shape is referred to as an R direction.

For example, in the secondary battery 1 illustrated in FIG. 1, the battery device 20 may be contained inside the battery can 11 having the cylindrical shape. A pair of insulating plates 12 and 13 may also be contained inside the battery can 11 having the cylindrical shape. A safety valve mechanism 30 may be attached to the battery can 11. The battery can 11 may be, for example, sealed by a battery cover 14. In an embodiment, the secondary battery 1 may further include components including, without limitation, a thermosensitive resistive device and a reinforcing member inside the battery can 11. Non-limiting examples of the thermosensitive resistive device may include a positive temperature coefficient (PTC) device. In the secondary battery 1 illustrated in FIG. 1, an end part on a side on which the battery cover 14 is provided in the Z direction may be referred to as an upper part, and an end part on an opposite side to the battery cover 14 in the Z direction may be referred to as a lower part.

The battery can 11 may correspond to a specific but non-limiting example of a “container” in an embodiment of the present disclosure. The battery cover 14 may correspond to a specific but non-limiting example of a “cover member” in an embodiment of the present disclosure.

The battery can 11 may be a container having a hollow structure that extends in the Z direction. The battery can 11 includes a first end part in the Z direction, and a second end part positioned on an opposite side to the first end part in the Z direction. The first end part may be open and the second end part may be closed. The first end part of the battery can 11 in the Z direction may be an open end part 11N. In an embodiment, the battery can 11 may include, for example, any one or more of metal materials including, without limitation, iron, aluminum, and alloys thereof. The battery can 11 may have a surface plated with, for example, any one or more of metal materials including, without limitation, nickel. In an embodiment, the battery can 11 may include an iron-based material including iron (Fe), such as stainless steel. One reason for this is that this secures physical strength of the battery can 11, which helps to suppress detachment of the battery cover 14 and leakage of an electrolytic solution even if an internal pressure of the battery can 11 increases. Non-limiting examples of the stainless steel may include SUS304 and SUS430.

The pair of insulating plates 12 and 13 may be disposed with the battery device 20 interposed therebetween in the Z direction and extend along a plane orthogonal to the Z direction.

In an embodiment, the battery cover 14 and the safety valve mechanism 30 may be crimped at the open end part 11N of the battery can 11 with a gasket 15 interposed between the open end part 11N and both the battery cover 14 and the safety valve mechanism 30. In an embodiment, the battery can 11 may thus be provided with a bent part 11P defining the open end part 11N.

The open end part 11N of the battery can 11 may be sealed by the battery cover 14 in a state where the battery device 20 and other components are contained inside the battery can 11. The battery can 11 may have a crimped structure 11R provided in the vicinity of the open end part 11N. The crimped structure 11R may be a structure in which the bent part 11P defining the open end part 11N and both the battery cover 14 and the safety valve mechanism 30 are crimped to each other with the gasket 15 interposed between the bent part 11P and both the battery cover 14 and the safety valve mechanism 30. A narrow part 11S may be provided between the bent part 11P and the insulating plate 12. The narrow part 11S may be a part of the battery can 11 that protrudes inward.

The bent part 11P may correspond to a specific but non-limiting example of a “crimp part” in an embodiment of the present disclosure. The crimped structure 11R may also be referred to as a crimp structure.

The battery cover 14 may be a cover member that closes the open end part 11N of the battery can 11. The battery cover 14 may be so attached to the bent part 11P, with the gasket 15 interposed therebetween, as to close the open end part 11N. The battery cover 14 and a safety cover 31 configure a cover part. The safety cover 31 will be described later. In an embodiment, the battery cover 14 may include a material similar to the material included in the battery can 11. However, in an embodiment, the battery cover 14 may include a material different from the material included in the battery can 11.

In an embodiment, the battery cover 14 may include an iron-based material including iron (Fe), such as stainless steel. One reason for this is that this secures physical strength of the battery cover 14 and accordingly secures physical strength of the crimped structure 11R, which helps to suppress the detachment of the battery cover 14 and the leakage of the electrolytic solution even if the internal pressure of the battery can 11 increases. Non-limiting examples of the stainless steel may include SUS304 and SUS430.

A middle part of the battery cover 14 may be provided with a projecting part 14T that protrudes in a direction away from the battery device 20, i.e., in a +Z direction. A part, of the battery cover 14, other than the middle part, in other words, a part surrounding the projecting part 14T, may be a flange 14F. The flange 14F of the battery cover 14 may be opposed, in the Z direction, to a flange 31F of the safety cover 31 included in the safety valve mechanism 30, and may be bonded to the flange 31F. The flange 31F will be described later. A part in which the flange 14F and the flange 31F are welded to each other may be referred to as a stacked part SS. The flange 14F may correspond to a specific but non-limiting example of a “first flange” in an embodiment of the present disclosure.

The gasket 15 may be a sealing member that seals a gap between the bent part 11P and the battery cover 14. The gasket 15 may be interposed between the bent part 11P of the battery can 11 and the battery cover 14.

The gasket 15 may include any one or more of insulating materials. Non-limiting examples of the insulating materials may include a polymer material such as polybutylene terephthalate (PBT) or polypropylene (PP). In an embodiment, the gasket 15 may include polypropylene. One reason for this is that this helps to allow for sufficient sealing of the gap between the bent part 11P and the battery cover 14, with the battery can 11 and the battery cover 14 being electrically separated from each other.

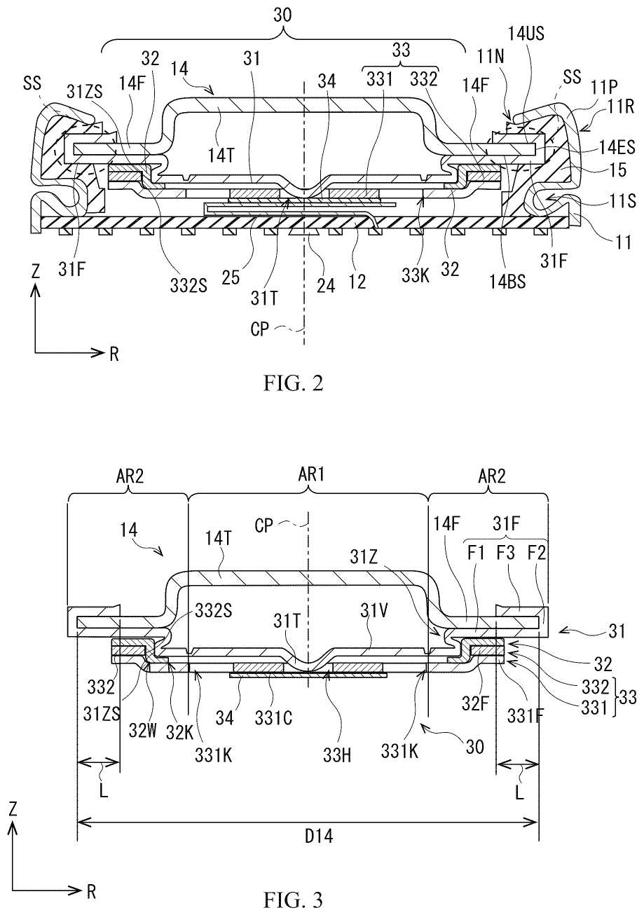

The safety valve mechanism 30 may be provided on an inner side of the battery cover 14 in the Z direction. The safety valve mechanism 30 may be a mechanism that, when the internal pressure of the battery can 11 increases, releases the internal pressure by unsealing the battery can 11 on an as-needed basis. Non-limiting examples of a cause of the increase in the internal pressure of the battery can 11 may include a gas generated due to a decomposition reaction of the electrolytic solution upon charging and discharging. An example detailed configuration of the safety valve mechanism 30 will be described later with reference to FIGS. 2 to 5 to be described later.

The battery device 20 is contained inside the battery can 11. In an embodiment, the battery device 20 may include a positive electrode 21, a negative electrode 22, and an electrolytic solution. The electrolytic solution may be a liquid electrolyte. Note that the electrolyte is not limited to the liquid electrolyte, and in an embodiment, may be a gel electrolyte, for example. The positive electrode 21 may correspond to a specific but non-limiting example of a “first electrode” in an embodiment of the present disclosure. The negative electrode 22 may correspond to a specific but non-limiting example of a “second electrode” in an embodiment of the present disclosure.

Here, the battery device 20 may be what is called a wound electrode body. That is, in the battery device 20, the positive electrode 21 and the negative electrode 22 may be stacked on each other with a separator 23 interposed therebetween, and the stack of the positive electrode 21, the negative electrode 22, and the separator 23 may be wound. The positive electrode 21, the negative electrode 22, and the separator 23 may each be impregnated with the electrolytic solution.

The battery device 20 may have, at the center thereof, a space resulting from winding the positive electrode 21, the negative electrode 22, and the separator 23. The space may be referred to as a center space 20C. A center pin 24 may be disposed in the center space 20C. In an embodiment, however, the center pin 24 may be omitted.

A positive electrode lead 25 may be coupled to the positive electrode 21. A negative electrode lead 26 may be coupled to the negative electrode 22. The positive electrode lead 25 may include any one or more of electrically conductive materials including, without limitation, a metal material. Non-limiting examples of the metal material included in the positive electrode lead 25 may include aluminum. The positive electrode lead 25 may be electrically coupled to the battery cover 14 via the safety valve mechanism 30. The negative electrode lead 26 may include any one or more of electrically conductive materials including, without limitation, a metal material. Non-limiting examples of the metal material included in the negative electrode lead 26 may include nickel. The negative electrode lead 26 may be electrically coupled to the battery can 11.

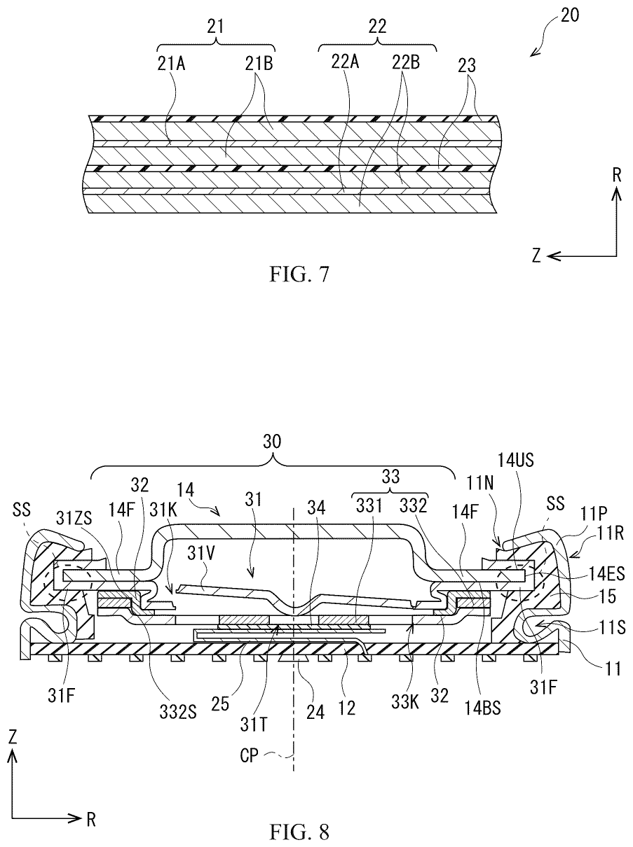

An example detailed configuration of the battery device 20, i.e., an example detailed configuration of each of the positive electrode 21, the negative electrode 22, the separator 23, and the electrolytic solution, will be described later with reference to FIG. 7.

FIG. 2 illustrates a part of a sectional configuration of the secondary battery 1 illustrated in FIG. 1, and more specifically, illustrates the safety valve mechanism 30 and the vicinity thereof. FIG. 3 is an enlarged sectional diagram illustrating, in an enlarged manner, a configuration example of the safety valve mechanism 30.

The safety valve mechanism 30 may include, for example, the safety cover 31, a disk holder 32, a stripper disk 33, and a sub-disk 34 as illustrated in FIG. 2. The safety cover 31 and the stripper disk 33 may be fixed to each other with the disk holder 32 interposed therebetween. In addition, the safety cover 31 and the stripper disk 33 may be electrically insulated from each other by the disk holder 32, in a part other than a coupling part. The coupling part may be provided in a middle region of each of the safety cover 31 and the stripper disk 33. The stripper disk 33 may be positioned closer to the battery device 20 than the safety cover 31. That is, the safety cover 31 may be provided between the stripper disk 33 and the battery cover 14. In addition, among the components included in the safety valve mechanism 30, the sub-disk 34 may be positioned closest to the battery device 20. That is, the sub-disk 34 may be provided between the stripper disk 33 and the battery device 20. The sub-disk 34 may be coupled to the positive electrode lead 25.

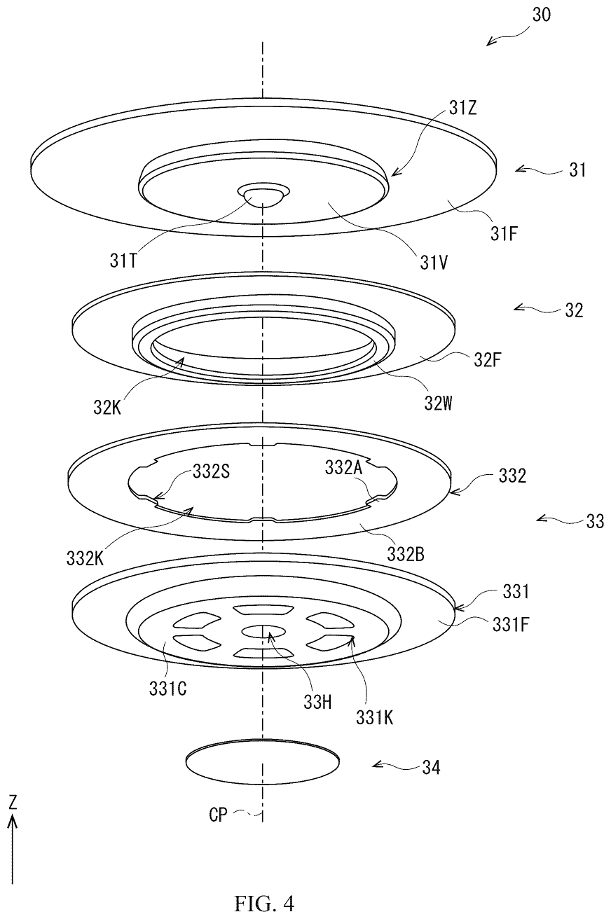

FIG. 4 is an exploded perspective diagram of the safety valve mechanism 30.

As illustrated in FIG. 2, the safety cover 31 may be opposed to a lower surface 14BS of the battery cover 14. The safety cover 31 may be cleavable in part, in response to the increase in the internal pressure of the battery can 11. As illustrated in FIG. 3, for example, the safety cover 31 may include a valve part 31V in a middle region AR1 of the safety valve mechanism 30. The valve part 31V may be cleavable in response to the increase in the internal pressure of the battery can 11. In an embodiment, when the safety cover 31 cleaves, the valve part 31V may cleave in part. In an embodiment, when the safety cover 31 cleaves, the entire valve part 31V may break. The safety cover 31 may correspond to a specific but non-limiting example of a “valve member” in an embodiment of the present disclosure.

In a peripheral region AR2 of the safety valve mechanism 30, the safety cover 31 may further include an annular protruding part 31Z. The annular protruding part 31Z may so extend as to surround the valve part 31V. The annular protruding part 31Z may include an end surface 31ZS on an outer side thereof in the R direction that is a radial direction of the secondary battery 1. The end surface 31ZS may be, as will be described later, opposed to an end surface 332S of the stripper disk 33 with an annular wall part 32W of the disk holder 32 interposed therebetween. A middle protruding part 31T may be provided at a center position of the valve part 31V, i.e., a position that overlaps the central axis CP. The middle protruding part 31T may protrude downward from the valve part 31V toward the battery device 20, and may be inserted through a through hole 33H to be in contact with an upper surface of the sub-disk 34. The through hole 33H will be described later.

In the peripheral region AR2, the safety cover 31 further includes the flange 31F. The flange 31F may be a circular annular part that is positioned on an outer side of the annular protruding part 31Z in the R direction, and extends along a horizontal plane orthogonal to the Z direction. The flange 31F may overlap the flange 14F of the battery cover 14 in the Z direction. In an embodiment, the flange 31F and the flange 14F may configure the stacked part SS.

The flange 31F may correspond to a specific but non-limiting example of a “second flange” in an embodiment of the present disclosure.

In an embodiment, the safety cover 31 may include any one or more of electrically conductive materials including, without limitation, a metal material. Non-limiting examples of the metal material may include aluminum and an aluminum alloy. A planar shape of the safety cover 31 is not particularly limited, and may be circular, for example. The “planar shape” may refer to a shape along a horizontal plane orthogonal to the Z direction. Hereinafter, the above-described definition of the planar shape is similarly applicable.

The disk holder 32 may be a member that is interposed between the safety cover 31 and the stripper disk 33 to align the stripper disk 33 with respect to the safety cover 31 and so hold the stripper disk 33 as to fix the stripper disk 33 to the safety cover 31. The disk holder 32 may include any one or more of insulating materials including, without limitation, a polymer material. Non-limiting examples of the polymer material may include polypropylene (PP) and polybutylene terephthalate (PBT).

A planar shape of the disk holder 32 is not particularly limited, and may be circular, for example. The disk holder 32 may have an opening 32K that passes through the disk holder 32 in the Z direction at a position that occupies the middle region AR1. The opening 32K may be a vent adapted to release the gas generated inside the battery can 11 to an outside. A planar shape of the opening 32K is not particularly limited, and may be circular, for example. In the peripheral region AR2, the disk holder 32 may include the annular wall part 32W. The annular wall part 32W may be so provided as to surround the annular protruding part 31Z along the horizontal plane orthogonal to the Z direction.

As illustrated in FIGS. 3 and 4, the disk holder 32 may further include a flange 32F. The flange 32F may be a circular annular part that extends along the horizontal plane orthogonal to the Z direction. The flange 32F may be sandwiched, in the Z direction, between the flange 31F of the safety cover 31 and a flange 331F of the stripper disk 33.

The stripper disk 33 may be a member that releases the gas generated inside the battery can 11. The stripper disk 33 may be configured to be electrically continuous with the valve part 31V of the safety cover 31 with the sub-disk 34 interposed therebetween. The safety cover 31 may be configured to be separated from the sub-disk 34 when the internal pressure of the secondary battery 1 increases. The valve part 31V of the safety cover 31 being separated from the sub-disk 34 may cut off the electrical continuity between the safety cover 31 and both the stripper disk 33 and the sub-disk 34, which may block a current inside the secondary battery 1. The stripper disk 33 may include any one or more of electrically conductive materials including, without limitation, a metal material. Non-limiting examples of the metal material may include aluminum and an aluminum alloy.

The stripper disk 33 may include a body part 331 and a claw member 332. The claw member 332 may be provided between the body part 331 and the disk holder 32. The body part 331 and the claw member 332 may be joined to each other by various methods including, without limitation, laser welding, resistance welding, and ultrasonic welding. The stripper disk 33 may be separated from the flange 31F of the safety cover 31. The flange 32F of the disk holder 32 may be sandwiched in a gap between the stripper disk 33 and the flange 31F.

A planar shape of the body part 331 is not particularly limited, and may be circular, for example. The body part 331 may include a middle part 331C having a circular plate shape and the flange 331F having an annular shape. The middle part 331C may occupy the middle region AR1. The flange 331F may be so provided in the peripheral region AR2 as to surround the middle part 331C along the horizontal plane. The middle part 331C may have a through hole 33H at a center position thereof. The through hole 33H may pass through the middle part 331C in the Z direction. The through hole 33H may allow the middle protruding part 31T to be disposed therein. The middle part 331C may further have an opening 331K that passes through the middle part 331C in the Z direction in the periphery of the through hole 33H. The opening 331K may be positioned to overlap the valve part 31V in the Z direction. As with the opening 32K, the opening 331K may be a vent adapted to release the gas generated inside the battery can 11 to the outside. Accordingly, as illustrated in FIG. 3, etc., the opening 331K may communicate with the opening 32K without being blocked by the disk holder 32. In other words, the body part 331 of the stripper disk 33 may be so provided as to occupy an entire region that overlaps the disk holder 32 in the Z direction. Such a configuration helps to maintain a state in which the disk holder 32 is held at a predetermined position even when the disk holder 32 is softened due to heating. In an embodiment, the body part 331 may have multiple openings 331K. One reason for this is that this helps to swiftly release the gas generated inside the battery can 11 to the outside, which in turn helps to achieve high safety. In an embodiment, the number of openings 331K is not particularly limited, and may be six or more and eight or less. One reason why the number of openings 331K is six or more is that this helps to more efficiently release the gas generated inside the battery can 11 to the outside, which in turn helps to achieve higher safety. One reason why the number of openings 331K is eight or less is that this helps to ensure sufficient mechanical strength, and to further reduce variations in pressure at which the valve part 31V as a safety valve operates.

A planar shape of the claw member 332 is not particularly limited, and may be annular, for example. The claw member 332 may include a claw part 332A, and an annular support part 332B that supports the claw part 332A. The annular support part 332B may be so joined to the flange 331F as to overlap the flange 331F in the Z direction. In an embodiment, multiple claw parts 332A may be so provided as to surround the annular protruding part 31Z of the safety cover 31 along the horizontal plane. One reason why the multiple claw parts 332A are provided along a direction circling around the central axis CP is that this helps to reduce variations in mechanical strength of the safety valve mechanism 30 due to a difference in a position of the safety valve mechanism 30 in the horizontal plane. As illustrated in FIG. 4, the claw parts 332A may each be provided on an inner side of the annular support part 332B, and may each protrude toward the central axis CP. The end surface 332S on a leading end of the claw part 332A may be opposed to the end surface 31ZS of the annular protruding part 31Z with the annular wall part 32W of the disk holder 32 interposed therebetween. In an embodiment, the number of claw parts 332A is not particularly limited, and may be six or more and nine or less. One reason why the number of claw parts 332A is six or more is that this helps to further reduce variations in the mechanical strength of the safety valve mechanism 30 due to the difference in the position of the safety valve mechanism 30 in the horizontal plane. One reason why the number of claw parts 332A is nine or less is that this helps to ensure processing accuracy and processing easiness of the claw parts 332A.

The sub-disk 34 may be a member that is interposed between the safety cover 31 and the positive electrode lead 25 to electrically couple the middle protruding part 31T of the safety cover 31 to the positive electrode lead 25. The sub-disk 34 may include any one or more of electrically conductive materials including, without limitation, a metal material. Non-limiting examples of the metal material may include aluminum and an aluminum alloy. A planar shape of the sub-disk 34 is not particularly limited, and may be circular, for example.

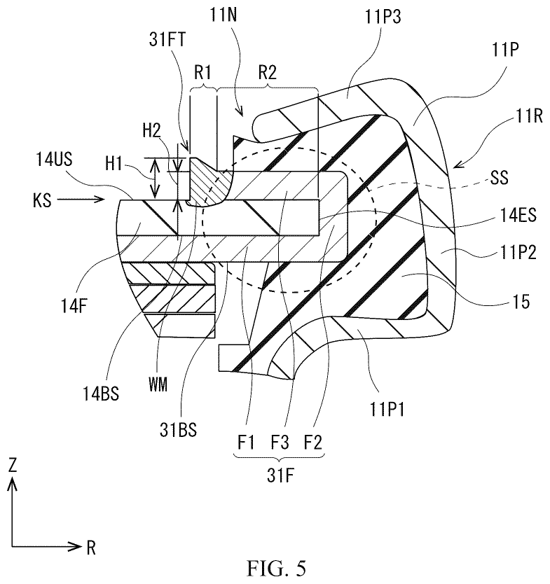

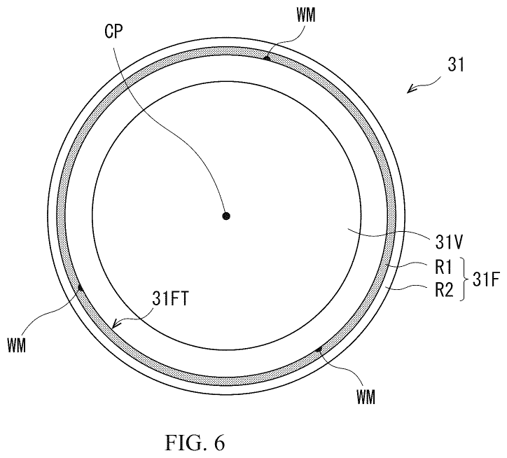

FIG. 5 is a partial sectional diagram illustrating, in an enlarged manner, a configuration example of the bent part 11P and the vicinity thereof. In an embodiment, as illustrated in FIG. 5, the flange 14F of the battery cover 14 and the flange 31F of the safety cover 31 may be welded to each other to configure the stacked part SS. In an embodiment, the stacked part SS may be held in the Z direction by the bent part 11P with the gasket 15 interposed therebetween. For example, the battery cover 14 and the the safety cover 31 of the safety valve mechanism 30 may be attached to the bent part 11P with the gasket 15 interposed between the bent part 11P and both the battery cover 14 and the safety cover 31. The stacked part SS may include a welding mark WM provided in the Z direction across an interface KS between an upper surface 14US of the flange 14F and an upper surface covering part F3 of the flange 31F. The upper surface covering part F3 will be described later. The welding mark WM may be formed by, for example, irradiation of an energetic beam such as a laser beam or an electron beam. The welding mark WM may be part in which a first material included in the battery cover 14, such as nickel plated stainless steel, and a second material included in the safety cover 31, such as aluminum or an aluminum alloy, are mixed with each other to form a solid solution. In an embodiment, the bent part 11P may include a lower surface opposing part 11P1, an end surface opposing part 11P2, and an upper surface opposing part 11P3. In an embodiment, the lower surface opposing part 11P1 may be opposed to the lower surface 14BS of the flange 14F. In an embodiment, the lower surface opposing part 11P1 may have the gasket 15 and a lower surface covering part F1 of the flange 31F interposed between the lower surface opposing part 11P1 and the lower surface 14BS of the flange 14F in the Z direction. The lower surface covering part F1 will be described later. In an embodiment, the end surface opposing part 11P2 may be opposed to an end surface 14ES of the flange 14F. In an embodiment, the end surface opposing part 11P2 may have the gasket 15 and an end surface covering part F2 of the flange 31F interposed between the end surface opposing part 11P2 and the end surface 14ES of the flange 14F in the R direction. The end surface covering part F2 will be described later. The end surface opposing part 11P2 may couple the lower surface opposing part 11P1 and the upper surface opposing part 11P3 to each other, and may extend substantially in the Z direction. The upper surface opposing part 11P3 may include the open end part 11N, and may extend substantially in the R direction. In an embodiment, the upper surface opposing part 11P3 may be opposed to the upper surface 14US of the flange 14F. In an embodiment, the upper surface opposing part 11P3 may have the gasket 15 and the upper surface covering part F3 of the flange 31F interposed between the upper surface opposing part 11P3 and the upper surface 14US of the flange 14F in the Z direction. In addition, the upper surface opposing part 11P3 may be opposed to the lower surface opposing part 11P1 in the Z direction with the stacked part SS interposed therebetween. The gasket 15 may be interposed between the stacked part SS and the upper surface opposing part 11P3, and between the stacked part SS and the lower surface opposing part 11P1. The crimped structure 11R may thus be provided with, in the following order from the upper part toward the lower part of the secondary battery 1 in the Z direction, the upper surface opposing part 11P3, the gasket 15, the upper surface covering part F3 of the flange 31F, the flange 14F, the lower surface covering part F1 of the flange 31F, the gasket 15, and the lower surface opposing part 11P1.

The flange 14F includes the lower surface 14BS, the upper surface 14US, and the end surface 14ES. The lower surface 14BS is opposed to the lower surface covering part F1 of the flange 31F. The upper surface 14US is on an opposite side to the lower surface 14BS, i.e., on an opposite side to the lower surface covering part F1 of the flange 31F. The end surface 14ES couples the lower surface 14BS and the upper surface 14US to each other. The end surface 14ES may be provided along an outer edge of the flange 14F. The flange 31F has a folded structure in which the flange 31F is folded back to continuously cover the flange 14F from the lower surface 14BS, via the end surface 14ES, to the upper surface 14US. For example, the flange 31F may include the lower surface covering part F1 that covers the lower surface 14BS, the end surface covering part F2 that covers the end surface 14ES, and the upper surface covering part F3 that covers the upper surface 14US. Here, the upper surface covering part F3 of the flange 31F includes a first part R1 having a first thickness H1 and a second part R2 having a second thickness H2. The first thickness H1 may be a maximum thickness in the first part R1. The second part R2 is positioned between the first part R1 and the end surface 14ES in the radial direction, i.e., the R direction. The second thickness H2 is smaller than the first thickness H1, i.e., H1>H2 is satisfied. The second thickness H2 may be a maximum thickness in the second part R2. In an embodiment, the first thickness H1 may be, for example, less than or equal to 120% of the second thickness H2. The bent part 11P may continuously cover the lower surface covering part F1, the end surface covering part F2, and the upper surface covering part F3 with the gasket 15 interposed between the bent part 11P and each of the covering part F1, the end surface covering part F2, and the upper surface covering part F3. In an embodiment, however, all or a part of the first part R1 may be exposed without being covered with the gasket 15.

In an embodiment, the second part R2 of the upper surface covering part F3 of the flange 31F may be interposed, in the Z direction, between the open end part 11N that is a leading end of the upper surface opposing part 11P3 of the bent part 11P and the upper surface 14US of the flange 14F.

FIG. 6 is a schematic plan diagram of the safety cover 31, and illustrates the safety cover 31 as viewed from a side opposite to the battery device 20 in the Z direction. In an embodiment, in a plan view of the safety cover 31 in the Z direction, the first part R1 and the second part R2 may each have an annular shape, and the first part R1 may be provided on an inner side of the second part R2, as illustrated in FIG. 6.

In an embodiment, the first part R1 of the upper surface covering part F3 may include, for example, a leading end part 31FT of the upper surface covering part F3, as illustrated in FIG. 5. In an embodiment, all or a part of the leading end part 31FT of the upper surface covering part F3 may be joined to the upper surface 14US of the flange 14F. For example, the welding mark WM may be discretely provided along the leading end part 31FT in a plane orthogonal to the Z direction. FIG. 6 illustrates an example case in which three welding marks WM are provided. In other words, in the example case of FIG. 6, the leading end part 31FT of the upper surface covering part F3 and the upper surface 14US of the flange 14F may be joined to each other at three positions.

In an embodiment, as illustrated in FIG. 3, a proportion of a width L of the upper surface covering part F3 in the R direction to a diameter D14 of the battery cover 14, i.e., L/D14, may be, for example, greater than or equal to 6.36% and less than or equal to 10.98%.

### [1-3. Example Detailed Configuration of Battery Device]

FIG. 7 illustrates, in an enlarged manner, a part of a sectional configuration of the battery device 20 illustrated in FIG. 1. In an embodiment, the battery device 20 may include the positive electrode 21, the negative electrode 22, the separator 23, and the electrolyte, as described above.

The positive electrode 21 may include, as illustrated in FIG. 7, a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the metal material may include aluminum.

In an example illustrated in FIG. 7, the positive electrode active material layer 21B may be provided on each of the two opposed surfaces of the positive electrode current collector 21A. The positive electrode active material layer 21B may include any one or more of positive electrode active materials into which lithium is insertable and from which lithium is extractable. Note that, in an embodiment, the positive electrode active material layer 21B may be provided simply on one of the two opposed surfaces of the positive electrode current collector 21A, on a side on which the positive electrode 21 is opposed to the negative electrode 22. In an embodiment, the positive electrode active material layer 21B may further include materials including, without limitation, a positive electrode binder and a positive electrode conductor. A method of forming the positive electrode active material layer 21B is not particularly limited, and may be, for example, a method such as a coating method.

The positive electrode active material may include a lithium compound. The lithium compound may be a compound including lithium as a constituent element, and may be, for example, a compound including lithium and one or more transition metal elements as constituent elements. One reason for this is that this helps to obtain a high energy density. Note that, in an embodiment, the lithium compound may further include any one or more of other elements, i.e., elements other than lithium and the transition metal elements.

The lithium compound is not particularly limited in kind, and non-limiting examples thereof may include a lithium composite oxide having a layered rock-salt crystal structure, a lithium composite oxide having a spinel crystal structure, and a lithium phosphoric acid compound having an olivine crystal structure. Non-limiting examples of the lithium composite oxide having the layered rock-salt crystal structure may include LiNiO₂, LiNi_{0.8}Co_{0.15}Al_{0.05}, and LiCoO₂. Non-limiting examples of the lithium composite oxide having the spinel crystal structure may include LiMn₂O₄. Non-limiting examples of the lithium phosphoric acid compound having the olivine crystal structure may include LiFePO₄ and LiMnPO₄.

In an embodiment, the positive electrode active material may include the lithium phosphoric acid compound having the olivine crystal structure. One reason for this is that, because the crystal structure of the lithium phosphoric acid compound having the olivine crystal structure is thermally stable, this helps to prevent the secondary battery 1 from easily exhibiting thermal runaway due to a cause such as overcharging or an internal short circuit. Another reason is that, because the crystal structure of the lithium phosphoric acid compound having the olivine crystal structure is firm, this helps to prevent the battery capacity from decreasing easily even if the secondary battery 1 is charged and discharged repeatedly.

The positive electrode binder may include any one or more of materials including, without limitation, a synthetic rubber and a polymer compound. Non-limiting examples of the synthetic rubber may include a styrene-butadiene-based rubber. Non-limiting examples of the polymer compound may include polyvinylidene difluoride.

The positive electrode conductor may include any one or more of electrically conductive materials including, without limitation, a carbon material. Non-limiting examples of the carbon material may include graphite, carbon black, acetylene black, and Ketjen black. Note that, in an embodiment, the electrically conductive material may be a metal material or a polymer compound, for example.

The negative electrode 22 may include, as illustrated in FIG. 7, a negative electrode current collector 22A and a negative electrode active material layer 22B.

The negative electrode current collector 22A may have two opposed surfaces on each of which the negative electrode active material layer 22B is to be provided. The negative electrode current collector 22A may include an electrically conductive material such as a metal material. Non-limiting examples of the metal material may include copper.

Here, the negative electrode active material layer 22B may be provided on each of the two opposed surfaces of the negative electrode current collector 22A, and may include any one or more of negative electrode active materials into which lithium is insertable and from which lithium is extractable. Note that, in an embodiment, the negative electrode active material layer 22B may be provided simply on one of the two opposed surfaces of the negative electrode current collector 22A, on a side on which the negative electrode 22 is opposed to the positive electrode 21. In an embodiment, the negative electrode active material layer 22B may further include materials including, without limitation, a negative electrode binder and a negative electrode conductor. Details of the negative electrode binder may be similar to those of the positive electrode binder. Details of the negative electrode conductor may be similar to those of the positive electrode conductor. A method of forming the negative electrode active material layer 22B is not particularly limited, and may include, for example, any one or more of methods including, without limitation, a coating method, a vapor-phase method, a liquid-phase method, a thermal spraying method, and a firing or sintering method.

The negative electrode active material may include a carbon material, a metal-based material, or both, for example. One reason for this is that this helps to obtain a high energy density. Non-limiting examples of the carbon material may include graphitizable carbon, non-graphitizable carbon, and graphite such as natural graphite or artificial graphite. The metal-based material may be a material that includes, as one or more constituent elements, any one or more elements among metal elements and metalloid elements that are each able to form an alloy with lithium. Non-limiting examples of such metal elements and metalloid elements may include silicon, tin, or both. Note that, in an embodiment, the metal-based material may be a simple substance, an alloy, a compound, a mixture of two or more thereof, or a material including two or more phases thereof. Non-limiting examples of the metal-based material may include TiSi₂ and SiOₓ (0<x≤2 or 0.2<x<1.4).

The separator 23 may be an insulating porous film interposed between the positive electrode 21 and the negative electrode 22, as illustrated in FIG. 7. The separator 23 may allow lithium ions to pass therethrough while preventing a short circuit between the positive electrode 21 and the negative electrode 22. The separator 23 may include a polymer compound such as polyethylene.

The electrolyte may be an electrolytic solution that includes a solvent and an electrolyte salt. The solvent may include any one or more of non-aqueous solvents, or organic solvents, including, without limitation, a carbonic-acid-ester-based compound, a carboxylic-acid-ester-based compound, and a lactone-based compound. An electrolytic solution including any of the non-aqueous solvents may be what is called a non-aqueous electrolytic solution. In an embodiment, however, the solvent may be an aqueous solvent. The electrolyte salt may include any one or more of light metal salts including, without limitation, a lithium salt. A content of the electrolyte salt is not particularly limited. In an embodiment, the content of the electrolyte salt may be within a range from 0.3 mol/kg to 3 mol/kg both inclusive with respect to the solvent. One reason for this is that this helps to obtain high ion conductivity.

FIG. 8 is an explanatory diagram for describing an operation of the secondary battery 1 of the present example embodiment, for example, behavior of the secondary battery 1 at a time when the internal pressure increases. FIG. 8 illustrates a sectional configuration corresponding to FIG. 2. In the following, an operation at a time of charging and discharging will be described, and thereafter, the operation at the time when the internal pressure increases will be described. In this case, reference is also made to FIG. 2 in addition to FIG. 8 where appropriate.

Upon charging, in the battery device 20, lithium may be extracted from the positive electrode 21, and the extracted lithium may be inserted into the negative electrode 22 via the electrolytic solution. Upon discharging, in the battery device 20, lithium may be extracted from the negative electrode 22, and the extracted lithium may be inserted into the positive electrode 21 via the electrolytic solution. Upon the charging and discharging, lithium may be inserted and extracted in an ionic state.

Upon charging and discharging of the secondary battery 1, when the internal pressure of the battery can 11 increases, the safety valve mechanism 30 may operate in order to prevent the secondary battery 1 from, for example, rupturing or being damaged.

For example, upon a normal operation of the secondary battery 1, the valve part 31V of the safety cover 31 may have not yet cleaved, as illustrated in FIG. 2. Therefore, an opening 332K of the stripper disk 33 may be closed by the safety cover 31.

When a gas is generated inside the battery can 11 due to a side reaction such as a decomposition reaction of the electrolytic solution, the generated gas may be accumulated inside the battery can 11, and the internal pressure of the battery can 11 may increase. Here, when the internal pressure of the battery can 11 reaches a certain level or higher, the valve part 31V of the safety cover 31 may cleave in part, as illustrated in FIG. 8. This may provide an opening 31K in the safety cover 31, which may open a gas releasing path using the openings 332K, 32K, and 31K. As a result, the gas generated inside the battery can 11 may be released through the openings 332K, 32K, and 31K. In addition, the valve part 31V of the safety cover 31 may be separated from the sub-disk 34. This may cut off the electrical continuity of the sub-disk 34 and the stripper disk 33 to the safety cover 31, and may block the current inside the secondary battery 1.

Note that depending on the level of the internal pressure of the secondary battery 1, the bent part 11P may be deformed, and the crimped structure 11R may therefore break. As a result, the battery cover 14 may be detached from the battery can 11, and the gas may thus be released to the outside of the secondary battery 1.

First, the positive electrode active material may be mixed with materials including, without limitation, the positive electrode binder and the positive electrode conductor on an as-needed basis to thereby obtain a positive electrode mixture. Thereafter, the positive electrode mixture may be dispersed in a solvent to thereby obtain a positive electrode mixture slurry in paste form. The solvent is not particularly limited in kind, and the solvent may be an aqueous solvent or a non-aqueous solvent, e.g., an organic solvent. Thereafter, the positive electrode mixture slurry may be applied on the two opposed surfaces of the positive electrode current collector 21A to thereby form the positive electrode active material layers 21B. Thereafter, the positive electrode active material layers 21B may be compression-molded using, for example, a roll pressing machine. In an embodiment, the positive electrode active material layers 21B may be heated. In an embodiment, the positive electrode active material layers 21B may be compression-molded multiple times. The positive electrode active material layers 21B may thus be formed on the respective two opposed surfaces of the positive electrode current collector 21A. As a result, the positive electrode 21 may be fabricated.

The negative electrode active material layers 22B may be formed on the respective two opposed surfaces of the negative electrode current collector 22A by a procedure similar to that of the positive electrode 21 described above. For example, the negative electrode active material may be mixed with materials including, without limitation, the negative electrode binder and the negative electrode conductor to thereby obtain a negative electrode mixture. Thereafter, the negative electrode mixture may be dispersed in a solvent to thereby obtain a negative electrode mixture slurry in paste form. Details of the solvent may be as described above. Thereafter, the negative electrode mixture slurry may be applied on the two opposed surfaces of the negative electrode current collector 22A to thereby form the negative electrode active material layers 22B. Thereafter, the negative electrode active material layers 22B may be compression-molded using, for example, a roll pressing machine. Details of compression molding may be as described above. The negative electrode active material layers 22B may thus be formed on the respective two opposed surfaces of the negative electrode current collector 22A. As a result, the negative electrode 22 may be fabricated.

First, the positive electrode lead 25 may be coupled to the positive electrode current collector 21A of the positive electrode 21 by a method such as a welding method. In a similar manner, the negative electrode lead 26 may be coupled to the negative electrode current collector 22A of the negative electrode 22 by a method such as a welding method. Thereafter, the positive electrode 21 and the negative electrode 22 may be stacked on each other with the separator 23 interposed therebetween to form a stacked body, following which the obtained stacked body may be wound to thereby form a wound body having the center space 20C. The wound body may have a configuration similar to that of the battery device 20 except that the positive electrode 21, the negative electrode 22, and the separator 23 are each not impregnated with the electrolytic solution. Thereafter, the center pin 24 may be placed in the center space 20C of the wound body.

Thereafter, the battery can 11 may be prepared, following which the insulating plates 12 and 13 may be opposed to each other with the wound body interposed therebetween, and the wound body, together with the insulating plates 12 and 13, may be placed inside the battery can 11. In this case, the positive electrode lead 25 may be coupled to the safety valve mechanism 30 by a method such as a welding method, and the negative electrode lead 26 may be coupled to the battery can 11 by a method such as a welding method.

Thereafter, the electrolytic solution may be injected into the battery can 11 to thereby impregnate the wound body with the electrolytic solution. Thus, the positive electrode 21, the negative electrode 22, and the separator 23 may each be impregnated with the electrolytic solution, and the battery device 20 may be fabricated. Thereafter, the safety valve mechanism 30 may be fabricated by stacking the safety cover 31, the disk holder 32, the stripper disk 33, and the sub-disk 34 in order as illustrated in FIG. 4. Further, the battery cover 14 may be placed on the safety cover 31, following which the flange 31F of the safety cover 31 may be so folded back as to cover the flange 14F of the battery cover 14 to form the stacked part SS. Thereafter, the upper surface covering part F3 of the flange 31F of the safety cover 31 may be welded to the flange 14F of the battery cover 14 by laser irradiation. Thereafter, the battery cover 14 and the safety valve mechanism 30 may be placed inside the battery can 11 together with the gasket 15.

Thereafter, the open end part 11N of the battery can 11 and both the battery cover 14 and the safety valve mechanism 30 may be crimped to each other with the gasket 15 interposed between the open end part 11N and both the battery cover 14 and the safety valve mechanism 30 at the open end part 11N, as illustrated in FIG. 1. The bent part 11P may thus be formed, and the crimped structure 11R may thereby be formed. As a result, the battery can 11 may be closed by the battery cover 14 to finish the assembly of the secondary battery 1.

The assembled secondary battery 1 may be charged and discharged. Various conditions including, for example, an environment temperature, the number of times of charging and discharging (the number of cycles), and charging and discharging conditions may be set as desired. A film may thus be formed on a location such as a location on a surface of the negative electrode 22. This may bring the secondary battery 1 into an electrochemically stable state. As a result, the secondary battery 1 of the cylindrical type may be completed in which the battery device 20 and other components are sealed inside the battery can 11.

In the secondary battery 1 according to the present example embodiment, the flange 31F of the safety cover 31 may be folded back to continuously cover the flange 14F of the battery cover 14 from the lower surface 14BS, via the end surface 14ES, to the upper surface 14US, to thereby form the stacked part SS. The stacked part SS may be held in the Z direction by the bent part 11P with the gasket 15 interposed therebetween. The bent part 11P may be provided at the open end part 11N of the battery can 11. This helps to allow the secondary battery 1 of the present example embodiment to achieve high sealing performance. For example, this helps to prevent the electrolyte included in the battery device 20 from leaking out from a gap between the battery can 11 and both the battery cover 14 and the safety valve mechanism 30 to the outside.

Further, in the secondary battery 1 according to the present example embodiment, the upper surface covering part F3 of the flange 31F includes the first part R1 having the first thickness H1 and the second part R2 having the second thickness H2. The second part R2 is positioned between the first part R1 and the end surface 14ES in the R direction. Here, the first thickness H1 is greater than the second thickness H2. Thus, for example, when the battery can 11 includes a metal material including iron (Fe) and the safety cover 31 includes a metal material including aluminum (Al), the configuration in which the first thickness H1 is greater than the second thickness H2 helps to suppress proceeding of a battery reaction even if a short circuit occurs due to adhesion of a substance such as salt water over the bent part 11P of the battery can 11 and the safety cover 31. This helps to ensure high safety.

A more detailed description will be given below. When the substance such as the salt water adheres to the open end part 11N of the bent part 11P of the secondary battery 1 and the upper surface covering part F3 of the safety cover 31 of the secondary battery 1, the positive electrode 21 and the negative electrode 22 may be externally short-circuited. One reason for this is that because the safety cover 31 is electrically coupled to the positive electrode 21 and the battery can 11 is electrically coupled to the negative electrode 22, the safety cover 31 and the battery can 11 are electrically continuous with each other through the salt water that includes an electrolyte. When such a short circuit occurs, aluminum included in the safety cover 31 serving as the positive electrode and iron included in the battery can 11 serving as the negative electrode may each dissolve. Thereafter, when the salt water is removed by a method such as evaporation or drying, aluminum may become at least one of an oxide or a hydroxide, and iron may become at least one of an oxide or a hydroxide. A mixture of at least one of the oxide of aluminum or the hydroxide of aluminum and at least one of the oxide of iron or the hydroxide of iron may continuously adhere to a part from the open end part 11N to the upper surface covering part F3. In the present example embodiment, the thickness of the first part R1 of the upper surface covering part F3 is greater than the thickness of the second part R2 of the upper surface covering part F3. Accordingly, a proportion of at least one of the aluminum oxide or the aluminum hydroxide in the mixture may increase. An insulation resistance of the aluminum oxide and an insulation resistance of the aluminum hydroxide are greater than an insulation resistance of the iron oxide and an insulation resistance of the iron hydroxide. Thus, for example, a resistance between the positive electrode and the negative electrode through the adhering mixture becomes relatively high as compared to when the thickness of the first part R1 and the thickness of the second part R2 are equal to each other. As a result, in the secondary battery 1 of the present example embodiment, the configuration in which the thickness of the first part R1 is greater than the thickness of the second part R2 helps to suppress occurrence of heat generation or smoke generation even if the external short circuit occurs due to the adhesion of the substance such as the salt water.

Further, in the secondary battery 1 of the present example embodiment, the positive electrode 21 may include the lithium phosphoric acid compound having the olivine crystal structure. This helps to prevent the secondary battery 1 from easily exhibiting the thermal runaway, and also to prevent the battery capacity from easily decreasing even if the secondary battery 1 is repeatedly charged and discharged, which in turn helps to achieve higher operation reliability. The positive electrode 21 may include a nickel-cobalt composite oxide of a layered rock-salt crystal structure. This helps to obtain a battery superior in balance between a large output characteristic and an energy density.

In an embodiment, the secondary battery 1 may include a lithium-ion secondary battery. This helps to allow a sufficient battery capacity to be obtained stably through insertion and extraction of lithium, which in turn helps to achieve higher operation reliability.

The configuration of the secondary battery 1 is appropriately modifiable as described below according to an embodiment. Note that any two or more of the following series of modification examples may be combined with each other.

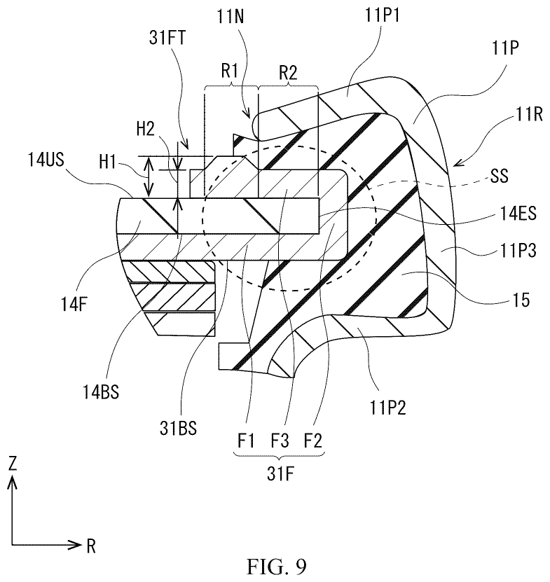

In the secondary battery 1 according to the example embodiment described above, the leading end part 31FT may be included in the first part R1. In an embodiment, however, as in a secondary battery according to a first modification example illustrated in FIG. 9, the secondary battery 1 of an embodiment of the present disclosure may have the first part R1 provided at a position retracted from the leading end part 31FT.

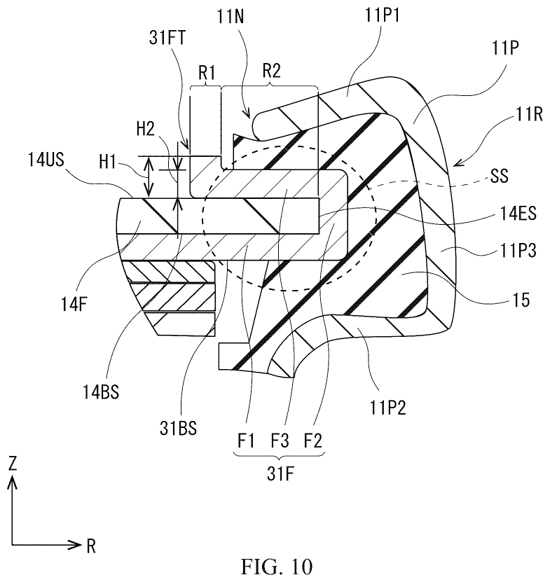

In an embodiment, as in a secondary battery according to a second modification example illustrated in FIG. 10, the secondary battery 1 of an embodiment of the present disclosure may have the first part R1 that is provided by bending upward the leading end part 31FT of the upper surface covering part F3.

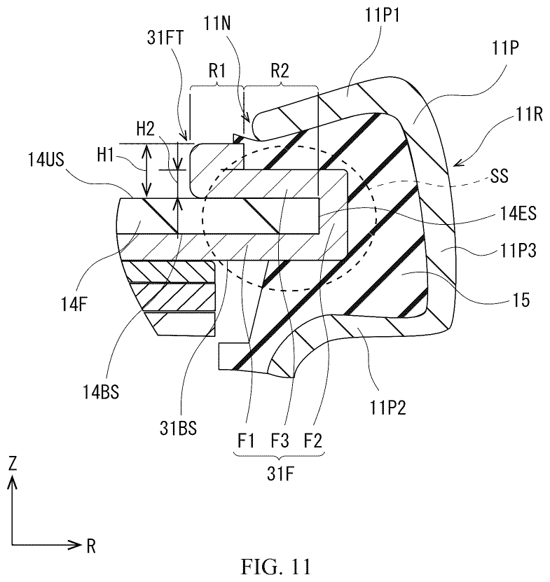

In an embodiment, as in a secondary battery according to a third modification example illustrated in FIG. 11, the secondary battery 1 of an embodiment of the present disclosure may have the first part R1 that is provided by further bending outward the leading end part 31FT of the upper surface covering part F3.

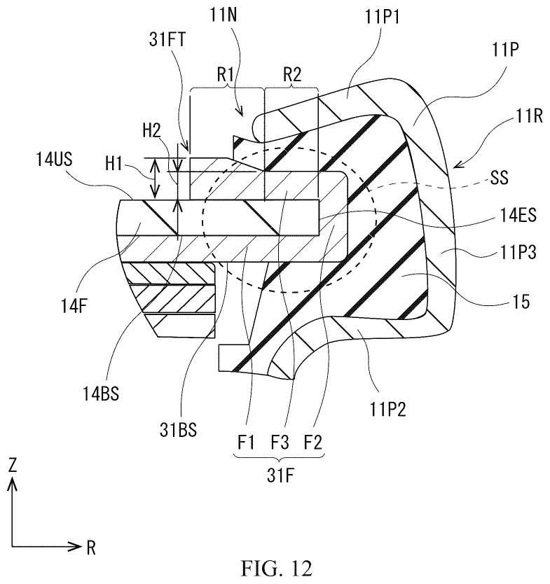

In the secondary battery 1 according to the example embodiment described above, the entire first part R1 may be exposed without being covered with the gasket 15. In an embodiment, however, as in a secondary battery according to a fourth modification example illustrated in FIG. 12, the secondary battery 1 of an embodiment of the present disclosure may have the first part R1 a part of which is covered with the gasket 15.

In the example embodiment described above, the electrolytic solution that is a liquid electrolyte may be used. In an embodiment, however, the secondary battery 1 of an embodiment of the present disclosure may include an electrolyte layer that is a gel electrolyte, instead of the electrolytic solution.

In the battery device 20 including the electrolyte layer, the positive electrode 21 and the negative electrode 22 may be stacked on each other with the separator 23 and the electrolyte layer interposed therebetween, and the stack of the positive electrode 21, the negative electrode 22, the separator 23, and the electrolyte layer may be wound. The electrolyte layer may be interposed between the positive electrode 21 and the separator 23, and between the negative electrode 22 and the separator 23.

For example, the electrolyte layer may include a polymer compound together with the electrolytic solution. The electrolytic solution may be held by the polymer compound in the electrolyte layer. One reason for this is that the leakage of the electrolytic solution is prevented. The electrolytic solution may have the configuration described above. The polymer compound may include, for example, polyvinylidene difluoride. To form the electrolyte layer, a precursor solution including, without limitation, the electrolytic solution, the polymer compound, and an organic solvent may be prepared, following which the precursor solution may be applied on one side or both sides of the positive electrode 21 and on one side or both sides of the negative electrode 22.

When the electrolyte layer is used also, lithium ions may be movable between the positive electrode 21 and the negative electrode 22 via the electrolyte layer, which helps to achieve similar effects.

Next, a description is given of applications (application examples) of of the secondary battery according to an embodiment.

The applications of the secondary battery are not particularly limited. The secondary battery used as a power source may serve as a main power source or an auxiliary power source in, for example but not limited to, electronic equipment, an electric vehicle, or any other application in which any embodiment of the present disclosure is usable. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted on, for example but not limited to, electronic equipment; medical electronic equipment; electric vehicles; and electric power storage systems. Non-limiting examples of the electronic equipment may include video cameras, digital still cameras, mobile phones, laptop personal computers, headphone stereos, portable radios, portable information terminals, and any other electronic equipment to which any embodiment of the present disclosure is applicable. Non-limiting examples of the apparatuses for data storage may include backup power sources, memory cards, and any other apparatus for data storage to which any embodiment of the present disclosure is applicable. Non-limiting examples of the electric power tools may include electric drills, electric saws, and any other electric power tool to which any embodiment of the present disclosure is applicable. Non-limiting examples of the medical electronic equipment may include pacemakers, hearing aids, and any other medical electronic equipment to which any embodiment of the present disclosure is applicable. Non-limiting examples of the electric vehicles may include electric automobiles including hybrid automobiles, and any other electric vehicle to which any embodiment of the present disclosure is applicable. Non-limiting examples of the electric power storage systems may include battery systems for home use or industrial use in which electric power is accumulated for a situation such as emergency, and any other electric power storage system to which any embodiment of the present disclosure is applicable. In an embodiment, one secondary battery may be used in each of the above-described applications. In an embodiment, multiple secondary batteries may be used in each of the above-described applications.

In an embodiment, the battery packs may each include a battery cell. In an embodiment, the battery packs may each include an assembled battery. In an embodiment, the electric vehicle may be a vehicle that operates or travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example but not limited to, home appliances and any other electrical appliance.

An application example of the secondary battery will now be described in detail. The configuration of the application example described below is merely an example, and is appropriately modifiable.

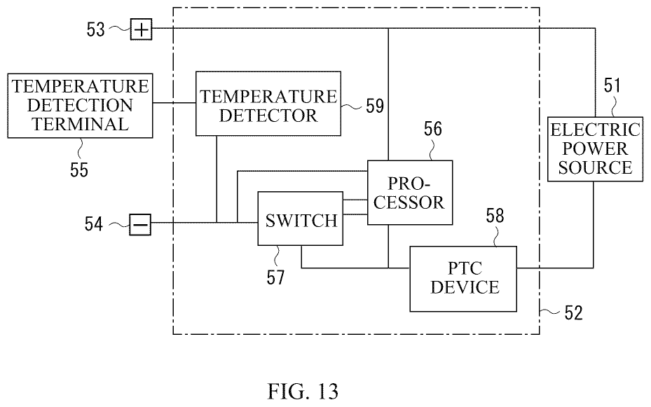

FIG. 13 illustrates a block configuration of a battery pack. The battery pack described here may be a battery pack, e.g., what is called a soft pack, including one secondary battery, and may be to be mounted on, for example, electronic equipment typified by a smartphone.

As illustrated in FIG. 13, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be couplable to outside via the positive electrode terminal 53 and the negative electrode terminal 54, and may thus be chargeable and dischargeable. The circuit board 52 may include a processor 56, a switch 57, a thermosensitive resistive device (a PTC device) 58, and a temperature detector 59. However, in an embodiment, the PTC device 58 may be omitted.

The processor 56 may include, for example, a central processing unit (CPU) and a memory, and may control an overall operation of the battery pack. The processor 56 may detect and control a use state of the electric power source 51 on an as-needed basis.

If a voltage of the electric power source 51 (the secondary battery) reaches an overcharge detection voltage or an overdischarge detection voltage, the processor 56 may turn off the switch 57. This helps to prevent a charging current from flowing into a current path of the electric power source 51. For example, the overcharge detection voltage may be 4.2 V±0.05 V and the overdischarge detection voltage may be 2.4 V±0.1 V.

The switch 57 may include, for example, a charge control switch, a discharge control switch, a charging diode, and a discharging diode. The switch 57 may perform switching between coupling and decoupling between the electric power source 51 and external equipment in accordance with an instruction from the processor 56. The switch 57 may include, for example, a metal-oxide-semiconductor field-effect transistor (MOSFET). The charging and discharging currents may be detected based on an ON-resistance of the switch 57.

The temperature detector 59 may include a temperature detection device such as a thermistor. The temperature detector 59 may measure a temperature of the electric power source 51 using the temperature detection terminal 55 and may output a result of the temperature measurement to the processor 56. The result of the temperature measurement to be obtained by the temperature detector 59 may be used, for example, when the processor 56 performs charge and discharge control upon abnormal heat generation or when the processor 56 performs a correction process upon calculating a remaining capacity.

### EXAMPLES

A description is given of Examples of an embodiment of the present disclosure.

### Example 1

Secondary batteries were fabricated, following which the secondary batteries were each evaluated for a battery characteristic as described below.

### [Fabrication of Secondary Battery]

The lithium-ion secondary battery of the cylindrical type illustrated in FIG. 1 (having a diameter, i.e., an outer diameter, of 21 mm, and a length of 70 mm) was fabricated in accordance with the following procedure.

### [Fabrication of Positive Electrode]

First, 94 parts by mass of the positive electrode active material (LiNi_{0.8}Co_{0.15}Al_{0.05}), 3 parts by mass of the positive electrode binder (polyvinylidene difluoride), and 3 parts by mass of the positive electrode conductor (graphite) were mixed with each other to thereby obtain a positive electrode mixture. Thereafter, the positive electrode mixture was put into a solvent (N-methyl-2-pyrrolidone as an organic solvent), following which the organic solvent was stirred to thereby prepare a positive electrode mixture slurry in paste form. Thereafter, the positive electrode mixture slurry was applied on each of the two opposed surfaces of the positive electrode current collector 21A (a band-shaped aluminum foil having a thickness of 15 μm) using a coating apparatus, following which the applied positive electrode mixture slurry was dried to thereby form the positive electrode active material layers 21B. Thereafter, the positive electrode active material layers 21B were compression-molded using a roll pressing machine.

### [Fabrication of Negative Electrode]

First, 95 parts by mass of the negative electrode active material (graphite), 3 parts by mass of the negative electrode binder (styrene-butadiene rubber (SBR)), and 2 parts by mass of the negative electrode conductor (carbon black) were mixed with each other to thereby obtain a negative electrode mixture. Thereafter, the negative electrode mixture was put into a solvent (water), following which the organic solvent was stirred to thereby prepare a negative electrode mixture slurry in paste form. Thereafter, the negative electrode mixture slurry was applied on each of the two opposed surfaces of the negative electrode current collector 22A (a band-shaped copper foil having a thickness of 15 μm) using a coating apparatus, following which the applied negative electrode mixture slurry was dried to thereby form the negative electrode active material layers 22B. Thereafter, the negative electrode active material layers 22B were compression-molded using a roll pressing machine.

### [Preparation of Electrolytic Solution]

The electrolyte salt (LiPF₆) was added to the solvent (ethylene carbonate, ethyl methyl carbonate, and dimethyl carbonate), following which the solvent was stirred. In this case, a mixture ratio or a weight ratio between ethylene carbonate, ethyl methyl carbonate, and dimethyl carbonate in the solvent was set to 20:20:60, and the content of the electrolyte salt was set to 1 mol/kg with respect to the solvent.

### [Assembly of Secondary Battery]

First, the positive electrode lead 25 including aluminum was welded to the positive electrode current collector 21A of the positive electrode 21, and the negative electrode lead 26 including nickel was welded to the negative electrode current collector 22A of the negative electrode 22. Thereafter, the positive electrode 21 and the negative electrode 22 were stacked on each other with the separator 23 (a porous polyethylene film having a thickness of 16 μm) interposed therebetween, following which the stack of the positive electrode 21, the negative electrode 22, and the separator 23 was wound to thereby fabricate the wound body having the center space 20C. Thereafter, the center pin 24 was placed in the center space 20C of the wound body.

Thereafter, the safety valve mechanism 30 that included the safety cover 31 including aluminum, the disk holder 32 including polybutylene terephthalate (PBT), and the stripper disk 33 including aluminum was prepared. Further, the battery cover 14 was placed on the safety cover 31, following which the flange 31F of the safety cover 31 was so folded back as to cover the flange 14F of the battery cover 14 to form the stacked part SS. Here, the diameter D14 of the battery cover 14 and the width L of the upper surface covering part F3 were set to respective values indicated in Table 1. The first thickness H1 of the first part R1 and the second thickness H2 of the second part R2 were also set to respective values indicated in Table 1 to be described later. Thereafter, the upper surface covering part F3 of the flange 31F of the safety cover 31 was welded to the flange 14F of the battery cover 14 by laser irradiation. At this time, the upper surface covering part F3 was so welded to the flange 14F at three positions that spacings between two adjacent ones of the three positions were substantially equal to each other in a plan view, as illustrated in FIG. 6, for example, to thereby form the welding marks WM.

Thereafter, the wound body was placed, together with the pair of insulating plates 12 and 13, inside the battery can 11 that included iron and was nickel-plated. The positive electrode lead 25 was welded to the stripper disk 33 of the safety valve mechanism 30, and the negative electrode lead 26 was welded to the battery can 11. Thereafter, the electrolytic solution was injected into the battery can 11 by a reduced-pressure method to thereby cause the wound body to be impregnated with the electrolytic solution.

Thereafter, asphalt was added to a solvent (ethylcyclohexane as an organic solvent), following which the solvent was stirred to thereby prepare a coating solution. Thereafter, the coating solution was applied to the gasket 15 including polypropylene.

Thereafter, the open end part 11N of the battery can 11 and both the battery cover 14 and the safety valve mechanism 30 were crimped to each other with the gasket 15 including polypropylene interposed between the open end part 11N and both the battery cover 14 and the safety valve mechanism 30, to thereby form the crimped structure 11R.

The open end part 11N of the battery can 11 was thus closed by the battery cover 14, and the battery device 20 and other components were contained inside the battery can 11. The lithium-ion secondary battery of the cylindrical type was thus assembled.

### [Stabilization of Secondary Battery]

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, i.e., 4.2 V, until a current reached 0.05 C. Upon discharging, the secondary battery was discharged with a constant current of 0.1 C until the voltage reached 3.0 V. Note that 0.1 C was a value of a current that caused a battery capacity, i.e., a theoretical capacity, of 4000 mAh to be completely discharged in 10 hours, and 0.05 C was a value of a current that caused the battery capacity of 4000 mAh to be completely discharged in 20 hours.

The state of the secondary battery was thus electrochemically stabilized. As a result, the lithium-ion secondary battery of the cylindrical type was completed.

### [Evaluation of Battery Characteristic]

The secondary batteries thus fabricated were each subjected to a water resistance evaluation as follows, and the evaluation revealed the results presented in Table 1. Specifically, the water resistance evaluation was performed by subjecting each of the secondary batteries to a voltage drop check test.

### [Voltage Drop Check Test]

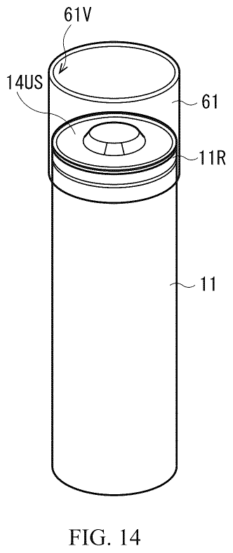

First, an open circuit voltage Vs of the secondary battery as a sample was measured (procedure 1). Thereafter, as illustrated in FIG. 14, for example, adhesive cellophane tape was wound around an outer peripheral surface of the crimped structure 11R one or more rounds to thereby form a wall part 61 having a cylindrical shape standing in the Z direction along an outer edge of the battery cover 14 (procedure 2). Thereafter, salt water having a concentration of 1 [%] was put in a space 61V surrounded by the battery cover 14 and the wall part 61, and was left for two hours (procedure 3). Thereafter, the adhesive cellophane tape was removed from the secondary battery. The secondary battery was turned upside down to cause the upper surface 14US of the battery cover 14 to face downward in a vertical direction, and was left in such an attitude for three hours or more. The secondary battery was allowed to dry naturally (procedure 4). After drying, an open circuit voltage Ve of the secondary battery was measured (procedure 5). A voltage drop rate [%] was determined by the following Expression (1) using the open circuit voltage Vs prior to the salt water immersion and the open circuit voltage Ve after the salt water immersion. The number of samples was set to five, and an average of values of the five samples was determined.

$$\{ ( Vs - Ve ) / Vs \} \times 100 [ \% ] \qquad ( 1 )$$

Regarding the open circuit voltages Vs and Ve, a battery tester was used to supply a constant alternating-current at a measurement frequency of 1 kHz, and the open circuit voltages Vs and Ve were each measured by an alternating-current voltmeter. At this time, the secondary battery was discharged with a constant current of 4.0 A in an atmosphere of 23±2° C. until the voltage reached 2.5 V. The obtained voltage drop rates [%] are presented in Table 1.

TABLE 1

| | | | | | Width L | | |
|---|---|---|---|---|---|---|---|
| | | | | Diameter | of upper | | |
| | First | Second | | D14 of | surface | | |
| | thickness | thickness | | battery | covering | | Voltage |
| | H1 | H2 | H1/H2 | cover | part | L/D14 | drop rate |
| | [mm] | [mm] | [%] | [mm] | [mm] | [%] | [%] |
| Example 1 | 0.300 | 0.303 | 101 | 15.57 | 1.36 | 8.73 | 0.40 |
| Example 2 | 0.300 | 0.330 | 110 | 15.57 | 1.36 | 8.73 | 0.25 |
| Example 3 | 0.300 | 0.360 | 120 | 15.57 | 1.36 | 8.73 | 0.13 |
| Example 4 | 0.300 | 0.370 | 123.3 | 15.57 | 1.36 | 8.73 | 0.10 |
| Example 5 | 0.300 | 0.330 | 110 | 15.57 | 1.69 | 10.85 | 0.10 |
| Example 6 | 0.300 | 0.330 | 110 | 15.57 | 1.04 | 6.68 | 0.40 |
| Example 7 | 0.300 | 0.330 | 110 | 15.57 | 1.71 | 10.98 | 0.05 |
| Example 8 | 0.300 | 0.330 | 110 | 15.57 | 0.99 | 6.36 | 0.60 |
| Comparative | 0.300 | 0.290 | 96.7 | 15.57 | 1.36 | 8.73 | 0.70 |
| example 1 | | | | | | | |
| Comparative | 0.300 | 0.300 | 100 | 15.57 | 1.36 | 8.73 | 0.50 |
| example 2 | | | | | | | |

### Examples 2 to 4

Secondary batteries of Examples 2 to 4 were each fabricated in a similar manner to Example 1, except that the second thickness H2 of the upper surface covering part F3 was changed as indicated in Table 1, and were each subjected to the evaluation of the battery characteristic similar to that in Example 1. The results of the evaluation are also presented in Table 1.

### Examples 5 to 8

Secondary batteries of Examples 5 to 8 were each fabricated in a similar manner to Example 1, except that the width L of the upper surface covering part F3 was changed as indicated in Table 1, and were each subjected to the evaluation of the battery characteristic similar to that in Example 1. The results of the evaluation are also presented in Table 1.

### Comparative Examples 1 and 2

Secondary batteries of Comparative examples 1 and 2 were each fabricated in a similar manner to Example 1, except that the second thickness H2 of the upper surface covering part F3 was changed as indicated in Table 1, and were each subjected to the evaluation of the battery characteristic similar to that in Example 1. The results of the evaluation are also presented in Table 1.

TABLE 2

| | | | | | Width L | | | |
|---|---|---|---|---|---|---|---|---|
| | | | | Diameter | of upper | | | |
| | First | Second | | D14 of | surface | | | |
| | thickness | thickness | | battery | covering | | Number of | Internal |
| | H1 | H2 | H1/H2 | cover | part | L/D14 | welding | resistance |
| | [mm] | [mm] | [%] | [mm] | [mm] | [%] | positions | [mΩ] |
| Example 2 | 0.300 | 0.330 | 110 | 15.57 | 1.36 | 8.73 | 3 | 17.0 |
| Example 9 | 0.300 | 0.330 | 110 | 15.57 | 1.36 | 8.73 | None | 17.2 |

Further, an internal resistance of the secondary battery of Example 2 was measured. A resistance based on when a constant alternating-current at a measurement frequency of 1 kHz was supplied was measured as the internal resistance. The result of the evaluation is presented in Table 2. In addition, a secondary battery of Example 9 was fabricated in a similar manner to Example 2, except that the upper surface covering part F3 of the flange 31F was not welded to the upper surface 14US of the battery cover 14, and the internal resistance was measured in the similar manner to Example 2. The result of the evaluation is also presented in Table 2.

### [Results]

As listed in Table 1, in each of Examples 1 to 7, the voltage drop rate was small as compared with each of Comparative examples 1 and 2. In other words, it was possible to slow down proceeding of the battery reaction in Examples 1 to 7 as compared to Comparative examples 1 and 2. Accordingly, it was confirmed that the secondary battery according to an example embodiment of the present disclosure achieved higher reliability.

Based on the results of Examples 1 to 4, it was confirmed that with an increase in the ratio H1/H2 of the first thickness H1 to the second thickness H2, the voltage drop rate was suppressed to be small. Note, however, that because the ratio H1/H2 in Example 4 exceeded 120%, it was confirmed that a defect tended to occur in the welding of the upper surface covering part F3 of the flange 31F to the upper surface 14US of the battery cover 14. In addition, in Example 7, because the ratio L/D14 of the width L of the upper surface covering part F3 to the diameter D14 of the battery cover 14 was greater than those of the other Examples, it was possible to suppress the voltage drop rate to be small. Note, however, that it was confirmed in Example 7 that a defect tended to occur in the welding of the upper surface covering part F3 of the flange 31F to the upper surface 14US of the battery cover 14. Further, based on comparison of Example 2 with Examples 6 and 8, it was confirmed that with a decrease in the ratio of the width L to the diameter D14, the voltage drop rate was suppressed to be small.

Although an embodiment of the present disclosure have been described hereinabove with reference to some example embodiments and Examples, the configuration of an embodiment of the present disclosure is not limited to the configurations described in relation to the example embodiments and Examples above, and is therefore modifiable in a variety of ways.

For example, the description has been given of the case where the battery device has a device structure of a wound type. However, the device structure of the battery device is not particularly limited. In an embodiment, the device structure may thus be another device structure such as a stacked type in which the electrodes, i.e., the positive electrode and the negative electrode, are stacked on each other, or a zigzag folded type in which the electrodes, i.e., the positive electrode and the negative electrode, are folded in a zigzag manner.

Further, although the description has been given of the case where the electrode reactant is lithium, the electrode reactant is not particularly limited. In an embodiment, the electrode reactant may be another alkali metal such as sodium or potassium, as described above. In an embodiment, the electrode reactant may be an alkaline earth metal such as beryllium, magnesium, or calcium, as described above. In an embodiment, the electrode reactant may be another light metal such as aluminum.

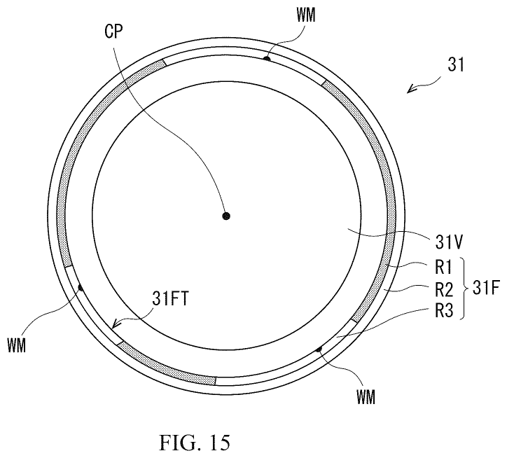

In the example embodiment described above, the upper surface covering part F3 of the flange 31F may include the first part R1 having the annular shape; however, the the present disclosure is not limited to such an example embodiment. In an embodiment, as in a secondary battery according to a fifth modification example illustrated in FIG. 15, the leading end part 31FT of the upper surface covering part F3 having an annular shape in a plan view may selectively include the first part R1 and a third part R3 in an extending direction of the leading end part 31FT. FIG. 15 is a schematic plan diagram of a safety valve mechanism of the secondary battery according to the fifth modification example. In an embodiment, the third part R3 may have a third thickness that is smaller than the first thickness H1. In an embodiment, the third thickness may be greater than or equal to the second thickness H2. In an embodiment, the third part R3 of the leading end part 31FT may be welded to the upper surface 14US of the flange 14F. In the present modification example, the third part R3 being joined to the upper surface 14US of the flange 14F helps to allow for favorable welding by irradiation of an energetic beam such as a laser beam or an electron beam having lower energy than when the first part R1 is joined to the upper surface 14US of the flange 14F. In addition, providing the first part R1 having a relatively large thickness helps to make it easier to stop proceeding of the battery reaction due to the external short circuit caused by the adhesion of the substance such as the salt water.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.
(1) A secondary battery including:
   a battery device;
   a container containing the battery device, the container including a first end part and a second end part, the second end part being positioned on an opposite side to the first end part in a first direction; and
   a cover part attached to the container with an insulating member interposed between the container and the cover part, in which
   the cover part includes a cover member and a valve member, the cover member including a first flange extending in a radial direction of the container, the radial direction being orthogonal to the first direction, the valve member including a second flange, the second flange extending in the radial direction and overlapping the first flange in the first direction, the valve member being positioned between the cover member and the battery device in the first direction,
   the first flange includes a lower surface, an upper surface on an opposite side to the lower surface, and an end surface coupling the lower surface and the upper surface to each other,
   the second flange is folded back to continuously cover the first flange from the lower surface, via the end surface, to the upper surface, and
   the second flange includes an upper surface covering part that covers the upper surface, the upper surface covering part including a first part having a first thickness and a second part having a second thickness that is smaller than the first thickness, the second part being positioned between the first part and the end surface in the radial direction.
(2) The secondary battery according to (1), in which
   the first end part of the container includes a crimp part, and
   the cover part is attached to the crimp part with a gasket interposed between the cover part and the crimp part.
(3) The secondary battery according to (2), in which the crimp part sandwiches, in the first direction, a stacked part with the gasket interposed between the crimp part and the stacked part, the stacked part including the first flange and the second flange that are stacked on each other.
(4) The secondary battery according to (3), in which all or a part of the first part is exposed without being covered with the gasket.
(5) The secondary battery according to any one of (2) to (4), in which the crimp part includes
   a lower surface opposing part that is opposed to the lower surface of the first flange with the gasket and the second flange interposed between the lower surface opposing part and the lower surface of the first flange,
   an end surface opposing part that is opposed to the end surface of the first flange with the gasket and the second flange interposed between the end surface opposing part and the end surface of the first flange, and
   an upper surface opposing part that is opposed to the upper surface of the first flange with the gasket and the second flange interposed between the upper surface opposing part and the upper surface of the first flange.
(6) The secondary battery according to (5), in which the second part of the upper surface covering part is interposed, in the first direction, between a leading end of the upper surface opposing part of the crimp part and the upper surface of the first flange.
(7) The secondary battery according to any one of (1) to (6), in which in a plan view of the cover part in the first direction, the first part and the second part each have an annular shape, and the first part is provided on an inner side of the second part.
(8) The secondary battery according to (7), in which the first part of the upper surface covering part includes a leading end part of the upper surface covering part.
(9) The secondary battery according to (8), in which all or a part of the leading end part of the upper surface covering part is joined to the upper surface of the first flange.
(10) The secondary battery according to any one of (1) to (9), in which the first thickness is less than or equal to 120 percent of the second thickness.
(11) The secondary battery according to any one of (1) to (9), in which a proportion of a width of the upper surface covering part in the radial direction to a diameter of the cover member is greater than or equal to 6.36 percent and less than or equal to 10.98 percent.
(12) The secondary battery according to (1), in which
   the upper surface covering part includes a leading end part having an annular shape in a plan view of the cover part in the first direction,
   the leading end part includes the first part and a third part, the third part having a third thickness that is smaller than the first thickness, and
   the third part of the leading end part is joined to the upper surface of the first flange.
(13) The secondary battery according to any one of (1) to (12), in which
   the valve member includes a metal material that includes aluminum (Al), and
   the container includes a metal material that includes iron (Fe).
(14) The secondary battery according to any one of (1) to (13), in which
   the battery device includes a first electrode and a second electrode,
   the cover part is electrically coupled to the first electrode, and
   the container is electrically coupled to the second electrode.

According to a secondary battery of at least an embodiment of the present disclosure, a second flange is folded back to continuously cover a first flange from a lower surface, via an end surface, to an upper surface. Such a cover part helps to achieve high sealing performance of a container. The second flange includes an upper surface covering part that covers the upper surface. The upper surface covering part includes a first part having a first thickness and a second part having a second thickness that is smaller than the first thickness. The second part is positioned between the first part and the end surface in a radial direction. This helps to suppress proceeding of a battery reaction when a short circuit occurs due to adhesion of a substance such as salt water, which in turn helps to ensure high safety.

Note that effects of an embodiment of the present disclosure are not necessarily limited to the example effects described above and may include any of a series of effects described herein in relation to the example embodiments of the present disclosure and the modification examples thereof.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device;
a container containing the battery device, the container including a first end part and a second end part, the second end part being positioned on an opposite side to the first end part in a first direction; and
a cover part attached to the container with an insulating member interposed between the container and the cover part, wherein
the cover part includes a cover member and a valve member, the cover member including a first flange extending in a radial direction of the container, the radial direction being orthogonal to the first direction, the valve member including a second flange, the second flange extending in the radial direction and overlapping the first flange in the first direction, the valve member being positioned between the cover member and the battery device in the first direction,
the first flange includes a lower surface, an upper surface on an opposite side to the lower surface, and an end surface coupling the lower surface and the upper surface to each other,
the second flange is folded back to continuously cover the first flange from the lower surface, via the end surface, to the upper surface, and
the second flange includes an upper surface covering part that covers the upper surface, the upper surface covering part including a first part having a first thickness and a second part having a second thickness that is smaller than the first thickness, the second part being positioned between the first part and the end surface in the radial direction.

2. The secondary battery according to claim 1, wherein
the first end part of the container includes a crimp part, and
the cover part is attached to the crimp part with a gasket interposed between the cover part and the crimp part.

3. The secondary battery according to claim 2, wherein the crimp part sandwiches, in the first direction, a stacked part with the gasket interposed between the crimp part and the stacked part, the stacked part including the first flange and the second flange that are stacked on each other.

4. The secondary battery according to claim 3, wherein at least a portion of the first part is exposed without being covered with the gasket.

5. The secondary battery according to claim 2, wherein the crimp part includes
a lower surface opposing part that is opposed to the lower surface of the first flange with the gasket and the second flange interposed between the lower surface opposing part and the lower surface of the first flange,
an end surface opposing part that is opposed to the end surface of the first flange with the gasket and the second flange interposed between the end surface opposing part and the end surface of the first flange, and
an upper surface opposing part that is opposed to the upper surface of the first flange with the gasket and the second flange interposed between the upper surface opposing part and the upper surface of the first flange.

6. The secondary battery according to claim 5, wherein the second part of the upper surface covering part is interposed, in the first direction, between a leading end of the upper surface opposing part of the crimp part and the upper surface of the first flange.

7. The secondary battery according to claim 1, wherein in a plan view of the cover part in the first direction, the first part and the second part each have an annular shape, and the first part is provided on an inner side of the second part.

8. The secondary battery according to claim 7, wherein the first part of the upper surface covering part includes a leading end part of the upper surface covering part.

9. The secondary battery according to claim 8, wherein all or a part of the leading end part of the upper surface covering part is joined to the upper surface of the first flange.

10. The secondary battery according to claim 1, wherein the first thickness is less than or equal to 120 percent of the second thickness.

11. The secondary battery according to claim 1, wherein a proportion of a width of the upper surface covering part in the radial direction to a diameter of the cover member is greater than or equal to 6.36 percent and less than or equal to 10.98 percent.

12. The secondary battery according to claim 1, wherein
the upper surface covering part includes a leading end part having an annular shape in a plan view of the cover part in the first direction,
the leading end part includes the first part and a third part, the third part having a third thickness that is smaller than the first thickness, and
the third part of the leading end part is joined to the upper surface of the first flange.

13. The secondary battery according to claim 1, wherein
the valve member includes a metal material that includes aluminum (Al), and
the container includes a metal material that includes iron (Fe).

14. The secondary battery according to claim 1, wherein
the battery device includes a first electrode and a second electrode,
the cover part is electrically coupled to the first electrode, and
the container is electrically coupled to the second electrode.
